(19) United States
(12) Patent Application Publication
(10) Pub. No.: US 2002/0103985 A1
(43) Pub. Date: Aug. 1, 2002

(54) Apparatus and method for storage of file address table file in a digital signal processor

(76) Inventor: Hans-Georg Gruber, Stafford, TX (US)

Correspondence Address: TEXAS INSTRUMENTS INCORPORATED, P O BOX 655474, M/S 3999, DALLAS, TX, 75265

(21) Appl. No.: 09/773,961

(22) Filed: Jan. 29, 2001

Related U.S. Application Data
(60) Provisional application No. 60/224,960, filed on Aug. 11, 2000.

(51) Int. Cl. G06F 12/08; G06F 9/28; G06F 9/34

(52) U.S. Cl. 711/215

(57) ABSTRACT

In a digital signal processor, a file address table (FAT) file is stored in the storage memory unit of the digital signal processor rather than in the program memory of the central processing unit. When a selected file is to be processed, a summary file is generated in the stack sector of the program memory, the summary file including the FAT file entries for the selected file. By positioning the FAT files in this manner, not only are locations in the program memory made available for the storage of other files, but the performance of the digital signal processor can be enhanced.

This application claims the benefit of U.S. Provisional Application No. 60/224,960, filed Aug. 11, 2000.

### BACKGROUND OF THE INVENTION

1. Field of the Invention

This invention relates generally to data processing apparatus and, more particularly, to the file address table (FAT) file in the specialized high performance processors generally referred to as digital signal processors. The FAT file provides a directory for use by the central processing unit of the addresses of programs stored in the storage memory unit of the digital signal processor.

2. Background of the Invention

The FAT file is a directory of program addresses used by the central processing unit of a digital signal processor to identify the location of programs and files in the storage memory unit that are required by the central processing unit. The FAT file is maintained by the central processing system. The central processing system updates the FAT file as programs and files are entered into and deleted from the storage memory unit.

Referring to FIG. 1A illustrating the prior art of the present invention, a digital signal processor 1 includes a central processing unit 10 and a storage memory unit 20. The central processing unit 10 executes programs and processes files that are stored in the storage memory unit 20. The storage memory unit 20 includes a multiplicity of locations for the storage of signal groups, each of the group of locations 21 storing at least a portion of a program or file. The central processing unit 10 includes a program memory 11, the program memory 11 including a stack section 113, a data memory 15, and execution/interrupt apparatus 16. (The program memory 11 can be provided with a program selectable size.) The program memory 11 stores programs being executed by the central processing unit 10, the stack section 113 of the program memory 11 storing those instructions that in a queue for execution. The data memory 15 includes those files that are to be processed by the central processing unit 10. The FAT file 111 is stored in the program memory 11. A stack section 113 holds a series of instructions being executed by execution/interrupt apparatus 16 of the central processing unit 10. The execution/interrupt apparatus 16 decodes and implements the current instruction in the stack section 113. The interrupt capability of the execution/interrupt apparatus 16 is used to prioritize the pending activity of the central processing unit 10.

Referring to FIG. 1B, the relationship of addresses of a selected file in the FAT file 111 and the related groups of locations in the storage memory unit 20 is shown. A selected file can be stored in a plurality of groups of locations 211, 212, -21N in the storage memory unit 20. In general, each of the groups of locations 211-21N will not be stored in locations identified by consecutive addresses. For a selected file, each entry 121-12N in the FAT file identifies a group of locations in the storage memory unit 20. For example, entry 122 in the memory section 111 includes the address (2) of a selected file portion 212 in the storage memory unit 20. In addition, each FAT file entry 121-12N includes a pointer that identifies the next entry, i.e., the pointer of entry 12S points to the entry 12(S+1). The entry 12(S+1) thereby identifies the next consecutive group of locations 21 (S+1) in the storage memory unit having portions of the selected file.

The operation of the digital signal processor using the FAT file 111 can be understood as follows. The central processing unit 10 requires signal groups from a selected file. The selected file is identified by a header of a first entry in the FAT file 121 associated with the selected file. The first entry 121 related to the selected file is transferred from the FAT file 111 in the program memory 11 to the stack section 113. In the stack section 113, the execution portion of the central processing unit 10 initiates the appropriate activity to determine whether the required signal groups are in the group of locations 211 in the storage memory unit 20 identified by the first related entry 121 in the FAT table 111. If the group of locations 211 in the storage memory unit 20 includes the signal groups required by the central processing unit 10, the required signal groups are transferred to data memory 15 and execution of the program is continued. When the signal groups required by central processing unit 10 are not in the group of locations 211 identified by the first FAT file entry 121, the pointer of the FAT file entry 121 is used to determine the next entry 122 in the FAT file 111 related to the selected file. The next FAT file entry 122 is moved to the stack section 113. This next entry 122 is used by the execution/interrupt apparatus 16 to determine whether the required signal groups are in the group of locations 212 determined by the address of the FAT file entry 122. If the required signal groups are in the group of locations 212, then the required signal groups are transferred to the data memory 15 for processing. When the required signal groups are not in the group of locations 212 identified by the address of the FAT file entry 122, the pointer of the FAT file entry 122 is used to determine the next FAT file entry 123 in the sequence. This next FAT file entry 213 is transferred to the stack section 113 and the process is continued until the required signal groups have been transferred to the data memory 15 or an end-of file signal is found in the current (i.e., last) FAT file entry 12N instead of a pointer.

While the foregoing procedure can provide the required signal groups in a selected file in the storage memory unit of the digital signal processor, problems non-the-less have arisen with this procedure. For example, the largely unused FAT file in the program memory 11 of the central processing unit 10 occupies memory space that could be used in a more useful manner to store program files required by the central processing unit 10. In addition, because access of the program memory 11 is provided on an interrupt basis, the transfer of a selected file from the storage memory unit 20 to the central processing unit can be relatively inefficient.

A need has therefore been felt for apparatus and an associated method that improves the operation of a digital signal processor when referencing the FAT file. It is a feature of the apparatus and associated method of the present invention that the FAT file is stored in the storage memory unit of the digital signal processor. It is a further feature of the present invention that the storage of the FAT file in the storage memory unit enhances the performance of the digital signal processor.

### SUMMARY OF THE INVENTION

The aforementioned and other features are accomplished, according to the present invention, by storing the FAT file in the storage memory unit of the digital signal processor. When signal groups from a selected file in the storage memory unit are required by the central processing unit, the entries in the FAT file are transferred to the stack section of the program memory until the first entry of the FAT file related to the selected file is identified (i.e., by the entry header). This first entry is stored in a selected file summary file in the stack section of the program memory. The pointer in the first entry is used to access and transfer the next entry in the FAT file related to the selected file. This next entry is added to the summary table. The process is continued until all of the entries of the FAT table related to the selected file are in the summary table. The resulting summary table, including only the entries of the FAT file related to the selected file, is thus created and stored in the stack section. The execution/interrupt apparatus consequently has immediate access to the FAT table entries associated with the selected file. Consequently, the execution/interrupt apparatus can efficiently access the signal groups in the groups of locations in which the selected file is stored.

### BRIEF DESCRIPTION OF THE DRAWINGS

The present invention may be better understood, and its numerous objects, features, and advantages made apparent to those skilled in the art by referencing the accompanying drawings.

FIG. 1A is a block diagram illustrating the relationship of the FAT table in the a digital signal processor according to the prior art, while FIG. 1B illustrates the generalized relationship of the FAT file to the selected file in the storage memory according to the prior art.

FIG. 2 is block diagram of the relationship of the FAT file to the associated digital signal processor according to the present invention.

The use of the same reference symbols in different drawings indicates similar or identical items.

### DESCRIPTION OF THE PREFERRED EMBODIMENTS

1. Detailed Description of the Figures

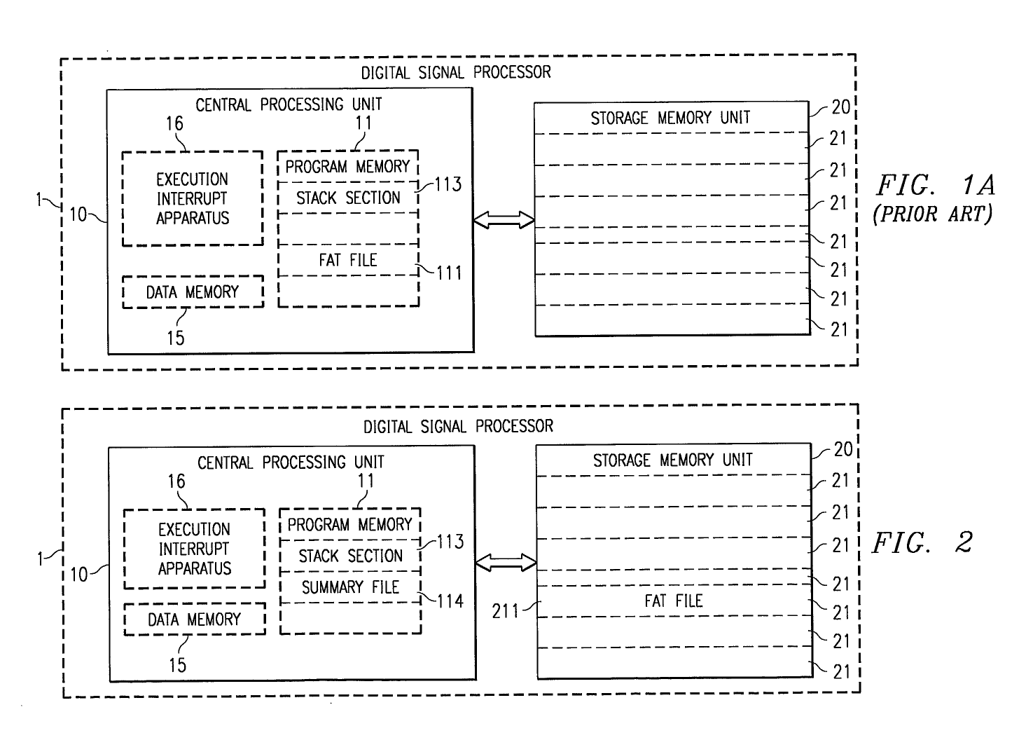

FIG. 1A and FIG. 1B have been discussed in the Background of the Invention.

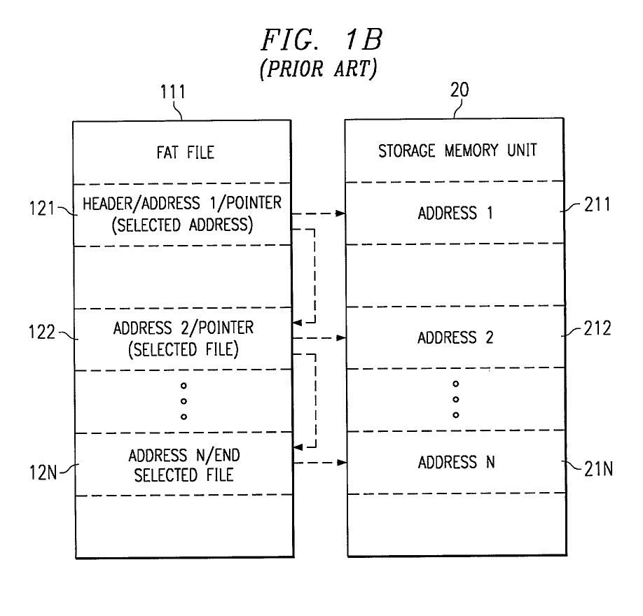

Referring now to FIG. 2, the relationship of the FAT file 211 and a digital signal processor 1 according to the present invention is shown. As in FIG. 1A, the digital signal processor includes a central processing unit 10 and a storage memory unit 20. The central processing unit 10 includes a program memory 11 having a stack section 113, a data memory 15, and execution/interrupt apparatus 16. The memory unit 20 includes a multiplicity of groups of storage locations 211. At least one of the group of storage locations 211 is used to store the FAT file rather than storing the FAT file in the program memory 11 of the central processing unit 10. The relationship of an entry of the FAT file 211 identifying a group of locations in the storage memory unit 20 storing signal groups is similar to that shown in FIG. 1B. The difference is that both the FAT file 211 and the related files identified by the FAT file 211 are located in the storage memory unit 20. When a selected file is required for processing by the central processing unit 10, the entries of the FAT file in 211 are transferred to stack section 113 of the program memory until the initial entry of the FAT table associated with the selected file is identified. The identification will be made by means of a header, cf. entry 121 in FIG. 1B. The entry 121 will be stored in a summary file 114 in the stack section. The pointer in entry 121 is used to identify the next entry, e.g., 122 in the FAT file 211 in FIG. 1B, associated with the selected file. This next entry 122 in the FAT file 211 is transferred to the stack section 113 wherein the entry is stored in the summary file 114. If the entry does not include an end-of-file signal group indicating that the current entry is not the last entry, then the procedure is continued until an end-of-file signal group is identified. At this point in the procedure, all of the entries of the FAT file 211 related to the selected file, i.e., the file which the central processing unit 10 needs to continue program execution, are stored in the summary file 114. Thus, to execute a program related to the selected file, the central processor need reference only the summary file 114in order to find the locations of the signal groups comprising the selected file. Because this summary file 114 resides in the stack section 113 of the program memory, this summary file 114 can be accessed without delay and the required signal groups in the storage memory unit 20 can be transferred to the data memory 15.

2. Operation of the Preferred Embodiments

As will be clear, the structure of the files is similar to the files of the prior art. However, the use of the files is different. First, by storing the complete FAT file in the storage memory unit, memory locations in program memory are made available for other uses. The FAT file itself can be substantial, particularly if the files in the storage memory are extensively fragmented. Although the creation of the summary file requires an increased processing, this additional processing is more than compensated for by increased speed with which the central processing unit can access the selected file by means of the summary file. The increased efficiency is the result of the fact that accessing the non-stack section of program memory generally requires an interrupt procedure. In the present invention, the summary file is stored in the stack section, so the interrupt procedure is not involved.

As will be clear to those skilled in the art, many features essential for the operation of a digital signal processor have been omitted in order to emphasize the operation of the present invention. For example, the central processing unit and the storage memory unit of a digital signal processing unit are typically coupled by a switch generally referred to as a direct memory access unit. The presence of a direct memory access unit is not required for an understanding of the operation of the invention.

While the invention has been described with respect to the embodiments set forth above, the invention is not necessarily limited to these embodiments. Accordingly, other embodiments, variations, and improvements not described herein are not necessarily excluded from the scope of the invention, the scope of the invention being defined by the following claims.

What is claimed is:

1. A digital signal processor comprising:
a central processing unit, the central processing unit including:
a program memory with a stack section, the stack section storing instructions being executed by the central processing unit;
execution/interrupt apparatus, and
a data memory for selected files being processed by the execution/interrupt apparatus; and
a storage memory unit, the storage memory unit storing a FAT file identifying the addresses in the storage memory unit of selected files, wherein the entries of the FAT file identifying groups of locations storing a selected file are stored in a summary file in the stack section.

2. The digital signal processor as recited in claim 1 wherein the execution/interrupt apparatus can access entries in the stack section without using an interrupt procedure.

3. The digital signal processor as recited in claim 1 wherein entries in the FAT files are used to identify the addresses of groups of locations in the storage memory unit storing portions of the selected files, groups of locations storing a selected file being transferred to the data memory in response activity by the execution/interrupt apparatus.

4. The digital signal processor of claim 1 wherein the summary table or entries of the FAT file identifying the selected file are formed in a summary file of the stack section by the central processing unit in response to a requirement for signal groups from the selected file stored in the storage memory unit.

5. The digital signal processor of claim 5 wherein the summary file is used to access the selected file in the storage memory unit.

6. A method for improving the operation of a digital signal processor having a central processing unit and a storage memory unit, the central processing unit including an execution/interrupt unit and a program memory having a stack section, the method comprising:
storing a FAT file in the storage memory unit, the Fat file entries identifying locations in the storage memory unit of files, and
when a portion of a selected file in a memory storage unit is required by the central processing unit, generating a summary file in the stack section of the program memory, the summary file including the FAT file entries identifying locations in the storage memory unit of the selected file.

7. The method of claim 6 wherein the execution/interrupt apparatus generates the summary file from selected entries in the FAT table, the selected entries identifying selected file location in the storage memory unit.

8. The method of claim 6 wherein the execution/interrupt apparatus accesses the summary file without an interrupt procedure.

9. The method of claim 6 further comprising the steps of:
accessing the summary file by the execution/interrupt apparatus to determine location of the selected file entries in the storage memory unit; and
transferring at least one selected file entry to the central processing unit.

10. In a digital signal processor, the digital signal processor including a central processing unit and a storage memory unit, the central processing unit including execution/interrupt apparatus and a program memory, the program memory having a stack section, the digital signal processor comprising:
files stored in plurality of locations in the storage memory unit;
a Fat file stored in the storage memory unit, the FAT file identifying locations of files in the storage memory unit; and
a summary file in the stack section, the summary file including entries of FAT file identifying locations in the storage memory unit of a selected file.

11. The digital signal processor of claim 10 wherein entries in the summary file can be accessed without an interrupt procedure.

12. The digital signal processor of claim 10 wherein the summary file is generated when the central processing unit requires signal groups from the selected file.

13. The digital signal processor of claim 12 wherein the execution/interrupt apparatus accesses the FAT file to generate the summary file.

14. The digital signal processor of claim 13 wherein the central processing unit further includes a data memory, the central processing unit determining locations of the selected file from the summary file, the central processing unit transferring a selected file entry to the data memory.
